(19) United States
(12) Patent Application Publication
(10) Pub. No.: US 2024/0349722 A1
(43) Pub. Date: Oct. 24, 2024

(54) COMPOSITION FOR ACCELERATING FRUIT RIPENING CONTAINING AMINO ACIDS

(71) Applicant: CJ CheilJedang Corporation, Seoul (KR)

(72) Inventors: Yuna KANG, Seoul (KR); Ju Yeon SON, Seoul (KR); Gyuree KIM, Seoul (KR); Youngjoo OH, Seoul (KR)

(73) Assignee: CJ CheilJedang Corporation, Seoul (KR)

(21) Appl. No.: 18/681,463

(22) PCT Filed: Aug. 5, 2022
(86) PCT No.: PCT/KR2022/011692

§ 371 Date: Feb. 5, 2024

(30) Foreign Application Priority Data
Feb. 9, 2022 (KR) 10-2022-0017109

(51) Int. Cl. A01N 37/44; A01G 7/06; A01G 17/00; A01N 43/36; A01P 21/00

(52) U.S. Cl. CPC A01N 37/44; A01G 7/06; A01G 17/005; A01N 43/36; A01P 21/00

(57) ABSTRACT

The present application relates to an amino acid that accelerates fruit ripening, and provides a use of the amino acid for accelerating fruit ripening. A composition containing the amino acid can achieve an excellent effect of promoting plant growth and/or fruit ripening.

### CROSS-REFERENCE TO RELATED APPLICATION(S)

### Technical Field

The present application claims the benefit of the priority based on Korean Patent Application No. 10-2022-0017109 filed on Feb. 9, 2022, and the entire contents disclosed in the document of the corresponding Korean patent application are incorporated as a part of the present description.

The present application relates to an amino acid with efficacy of promoting fruit ripening and a use thereof.

### Background Art

It is known that the fruits of coffee trees (coffee cherries/coffee berries) ripen un-uniformly due to the sequential flowering event, which is a difficult point in coffee cultivation. When the ripened fruits are harvested by machine, a post-harvest process removing un-ripened coffee cherries is also required, which makes a great demand for uniforming the ripening time of the fruits to reduce this process.

On the other hand, according to the transcriptome analysis, it is known that when amino acids are treated to plants, it functions in various mechanisms in the plant such as promotion of growth of the above-ground part and underground part, increase of flowering and fruiting rate, improvement of resistance to biological or environmental stress, and the like, thereby affecting growth and development of the plant.

Accordingly, it is necessary to develop a technology that can improve fruit quality by facilitating the selection process after harvest through promoting fruit ripening and reducing the difference in the degree of ripening of the fruits.

### PRIOR ART

### Patent Document

(Patent document 1) US 2017-0000143 A1

### DISCLOSURE

### Technical Problem

An object of the present application is to provide a composition for promoting fruit ripening, comprising amino acids as an active ingredient.

Another object of the present application is to provide a fertilizer composition comprising amino acids as an active ingredient.

Other object of the present application is to provide a method for cultivating plants, or a method for promoting fruit ripening, comprising a step of treating amino acids to plants.

Other object of the present application is to provide a use of the amino acids for promoting fruit ripening.

Other object of the present application is to provide a use of amino acids for preparation of the composition for promoting fruit ripening.

### Technical Solution

This will be described in detail as follows. On the other hand, each description and embodiment disclosed in the present application may be applied to each other description and embodiment. In other words, all combinations of various elements disclosed in the present application fall within the scope of the present application. In addition, it cannot be seen that the scope of the present application is limited by the detailed description described below. Furthermore, those skilled in the art can recognize or confirm many equivalents to the specific aspect of the present application disclosed in the present application, using only common experiments. In addition, these equivalents are intended to be comprised in the present application.

Hereinafter, the present application will be described in more detail.

Amino acids

The amino acid provided herein may be at least one (for example, one or more kinds, 2 or more kinds, 3 or more kinds, 4 or more kinds, or 5 or more kinds, or one kind, 2 kinds, 3 kinds, 4 kinds, 5 kinds or 6 kinds) amino acid selected from the group consisting of methionine (Met), arginine (Arg), glutamic acid (Glu), histidine (His), threonine (Thr), and lysine (Lys) or a salt thereof.

In the present description, when the term “amino acid” is used alone, this may be used to mean both the amino acid or salt of the amino acid. In addition, the amino acid or salt thereof may be described as “amino acids”.

In one embodiment, the salt of histidine may be hydrochloride of histidine (His-HCl), and the salt of glutamic acid may be sodium salt of glutamic acid (sodium glutamate, MSG, monosodium glutamate), and the salt of lysine may be hydrochloride of lysine (Lys-HCl).

Herein, the salt of the amino acid may mean a physiologically acceptable salt among salts which are substances in which a cation and an anion are combined by electrostatic attraction, and for example, may mean a salt applicable to plant cultivation. For example, the salt may be at least one kind selected from the group consisting of metal salts, salts with organic bases, salts with inorganic acids, salts with organic acids, and the like. In one embodiment, the metal salts may be at least one kind selected from the group consisting of alkali metal salts (sodium salts, potassium salts, etc.), alkali earth metal salts (calcium salts, magnesium salts, barium salts, etc.), aluminum salts, and the like; and the salts with organic bases may be at least one kind selected from the group consisting of salts with triethylamine, pyridine, picoline, 2,6-lutidine, ethanolamine, diethanolamine, triethanolamine, cyclohexylamine, dicyclohexylamine, N,N-dibenzylethylenediamine, and the like; and the salts with inorganic acids may be at least one kind selected from the group consisting of salts with hydrochloric acid, hydrobromic acid, nitric acid, sulfuric acid, phosphoric acid, and the like; and the salts with organic acids may be at least one kind selected from the group consisting of salts with formic acid, acetic acid, trifluoroacetic acid, phthalic acid, fumaric acid, oxalic acid, tartaric acid, maleic acid, citric acid, succinic acid, methane sulfonic acid, benzene sulfonic acid, p-toluene sulfonic acid, and the like.

In one embodiment, the amino acid may be,
a combination of at least 2 kinds of amino acids selected from the group consisting of methionine, arginine, threonine, glutamic acid, histidine and lysine or a salt thereof.

In one embodiment, the amino acid may be,
a combination of methionine; and,
at least one amino acid selected from the group consisting of arginine, threonine, glutamic acid, histidine and lysine.

In one embodiment, the amino acid may be,
a combination of methionine or a salt thereof; and,
at least 2 kinds (for example, 2 or more kinds, 3 or more kinds, or 4 or more kinds, or one kind, 2 kinds, 3 kinds, 4 kinds or 5 kinds) selected from the group consisting of arginine, threonine, glutamic acid, histidine, and lysine or a salt thereof.

In one embodiment, the amino acid may be,
a combination of at least one (for example, one or more kinds, 2 or more kinds, or one kind, 2 kinds, 3 kinds) amino acid selected from the group consisting of methionine, threonine, and lysine or a salt thereof; and,
at least one (for example, one or more kinds, 2 or more kinds, or one kind, 2 kinds, 3 kinds) amino acid selected from the group consisting of arginine, glutamic acid, and histidine or a salt thereof.

In one embodiment, the amino acid may be,
1) a combination of methionine, arginine or a salt thereof, glutamic acid or a salt thereof, and histidine or a salt thereof,
2) a combination of methionine, arginine or a salt thereof, threonine, histidine or a salt thereof, and lysine or a salt thereof, or
3) a combination of methionine, threonine, glutamic acid or a salt thereof, and lysine or a salt thereof.

In one embodiment, the amino acid may be,
1) a combination of methionine, arginine, glutamic acid and histidine,
2) a combination of methionine, arginine, threonine, histidine and lysine, or
3) a combination of methionine, threonine, glutamic acid and lysine.

In one embodiment, when at least 2 kinds of amino acids among the amino acids or a salt thereof are used in combination, the ratio of each amino acid or a salt thereof (a combination ratio of the amino acid or salt thereof) may be as follows based on the weight of each amino acid or a salt thereof.

In one embodiment, the amino acid may be a combination of at least one (for example, one or more kinds, 2 or more kinds, 3 or more kinds, or 4 or more kinds, or one kind, 2 kinds, 3 kinds, 4 kinds or 5 kinds) amino acid selected from the group consisting of
methionine of 1 part by weight; and
arginine of 1 to 5 parts by weight, 1 to 4.67 parts by weight, 1 to 4.33 parts by weight, 1 to 4 parts by weight, 1 to 3.67 parts by weight, 1 to 3.33 parts by weight, 1 to 3 parts by weight, 1 to 2.67 parts by weight, 1 to 2.33 parts by weight, 1 to 2 parts by weight, 1 to 1.67 parts by weight, 1 to 1.33 parts by weight, 1.33 to 5 parts by weight, 1.33 to 4.67 parts by weight, 1.33 to 4.33 parts by weight, 1.33 to 4 parts by weight, 1.33 to 3.67 parts by weight, 1.33 to 3.33 parts by weight, 1.33 to 3 parts by weight, 1.33 to 2.67 parts by weight, 1.33 to 2.33 parts by weight, 1.33 to 2 parts by weight, 1.33 to 1.67 parts by weight, 1.67 to 5 parts by weight, 1.67 to 4.67 parts by weight, 1.67 to 4.33 parts by weight, 1.67 to 4 parts by weight, 1.67 to 3.67 parts by weight, 1.67 to 3.33 parts by weight, 1.67 to 3 parts by weight, 1.67 to 2.67 parts by weight, 1.67 to 2.33 parts by weight, 1.67 to 2 parts by weight, 2 to 5 parts by weight, 2 to 4.67 parts by weight, 2 to 4.33 parts by weight, 2 to 4 parts by weight, 2 to 3.67 parts by weight, 2 to 3.33 parts by weight, 2 to 3 parts by weight, 2 to 2.67 parts by weight, 2 to 2.33 parts by weight, 2.33 to 5 parts by weight, 2.33 to 4.67 parts by weight, 2.33 to 4.33 parts by weight, 2.33 to 4 parts by weight, 2.33 to 3.67 parts by weight, 2.33 to 3.33 parts by weight, 2.33 to 3 parts by weight, 2.33 to 2.67 parts by weight, 2.67 to 5 parts by weight, 2.67 to 4.67 parts by weight, 2.67 to 4.33 parts by weight, 2.67 to 4 parts by weight, 2.67 to 3.67 parts by weight, 2.67 to 3.33 parts by weight, 2.67 to 3 parts by weight, 3 to 5 parts by weight, 3 to 4.67 parts by weight, 3 to 4.33 parts by weight, 3 to 4 parts by weight, 3 to 3.67 parts by weight, 3 to 3.33 parts by weight, 3.33 to 5 parts by weight, 3.33 to 4.67 parts by weight, 3.33 to 4.33 parts by weight, 3.33 to 4 parts by weight, 3.33 to 3.67 parts by weight, 1 part by weight, or 2.67 parts by weight,
glutamic acid of 1 to 5 parts by weight, 1 to 4.67 parts by weight, 1 to 4.33 parts by weight, 1 to 4 parts by weight, 1 to 3.67 parts by weight, 1 to 3.33 parts by weight, 1 to 3 parts by weight, 1 to 2.67 parts by weight, 1 to 2.33 parts by weight, 1 to 2 parts by weight, 1 to 1.67 parts by weight, 1 to 1.33 parts by weight, 1.33 to 5 parts by weight, 1.33 to 4.67 parts by weight, 1.33 to 4.33 parts by weight, 1.33 to 4 parts by weight, 1.33 to 3.67 parts by weight, 1.33 to 3.33 parts by weight, 1.33 to 3 parts by weight, 1.33 to 2.67 parts by weight, 1.33 to 2.33 parts by weight, 1.33 to 2 parts by weight, 1.33 to 1.67 parts by weight, 1.67 to 5 parts by weight, 1.67 to 4.67 parts by weight, 1.67 to 4.33 parts by weight, 1.67 to 4 parts by weight, 1.67 to 3.67 parts by weight, 1.67 to 3.33 parts by weight, 1.67 to 3 parts by weight, 1.67 to 2.67 parts by weight, 1.67 to 2.33 parts by weight, 1.67 to 2 parts by weight, 2 to 5 parts by weight, 2 to 4.67 parts by weight, 2 to 4.33 parts by weight, 2 to 4 parts by weight, 2 to 3.67 parts by weight, 2 to 3.33 parts by weight, 2 to 3 parts by weight, 2 to 2.67 parts by weight, 2 to 2.33 parts by weight, 2.33 to 5 parts by weight, 2.33 to 4.67 parts by weight, 2.33 to 4.33 parts by weight, 2.33 to 4 parts by weight, 2.33 to 3.67 parts by weight, 2.33 to 3.33 parts by weight, 2.33 to 3 parts by weight, 2.33 to 2.67 parts by weight, 2.67 to 5 parts by weight, 2.67 to 4.67 parts by weight, 2.67 to 4.33 parts by weight, 2.67 to 4 parts by weight, 2.67 to 3.67 parts by weight, 2.67 to 3.33 parts by weight, 2.67 to 3 parts by weight, 3 to 5 parts by weight, 3 to 4.67 parts by weight, 3 to 4.33 parts by weight, 3 to 4 parts by weight, 3 to 3.67 parts by weight, 3 to 3.33 parts by weight, 3.33 to 5 parts by weight, 3.33 to 4.67 parts by weight, 3.33 to 4.33 parts by weight, 3.33 to 4 parts by weight, 3.33 to 3.67 parts by weight, 2.67 parts by weight, or 3.33 parts by weight,
histidine of 1 to 5 parts by weight, 1 to 4.67 parts by weight, 1 to 4.33 parts by weight, 1 to 4 parts by weight, 1 to 3.67 parts by weight, 1 to 3.33 parts by weight, 1 to 3 parts by weight, 1 to 2.67 parts by weight, 1 to 2.33 parts by weight, 1 to 2 parts by weight, 1 to 1.67 parts by weight, 1 to 1.33 parts by weight, 1.33 to 5 parts by weight, 1.33 to 4.67 parts by weight, 1.33 to 4.33 parts by weight, 1.33 to 4 parts by weight, 1.33 to 3.67 parts by weight, 1.33 to 3.33 parts by weight, 1.33 to 3 parts by weight, 1.33 to 2.67 parts by weight, 1.33 to 2.33 parts by weight, 1.33 to 2 parts by weight, 1.33 to 1.67 parts by weight, 1.67 to 5 parts by weight, 1.67 to 4.67 parts by weight, 1.67 to 4.33 parts by weight, 1.67 to 4 parts by weight, 1.67 to 3.67 parts by weight, 1.67 to 3.33 parts by weight, 1.67 to 3 parts by weight, 1.67 to 2.67 parts by weight, 1.67 to 2.33 parts by weight, 1.67 to 2 parts by weight, 2 to 5 parts by weight, 2 to 4.67 parts by weight, 2 to 4.33 parts by weight, 2 to 4 parts by weight, 2 to 3.67 parts by weight, 2 to 3.33 parts by weight, 2 to 3 parts by weight, 2 to 2.67 parts by weight, 2 to 2.33 parts by weight, 2.33 to 5 parts by weight, 2.33 to 4.67 parts by weight, 2.33 to 4.33 parts by weight, 2.33 to 4 parts by weight, 2.33 to 3.67 parts by weight, 2.33 to 3.33 parts by weight, 2.33 to 3 parts by weight, 2.33 to 2.67 parts by weight, 2.67 to 5 parts by weight, 2.67 to 4.67 parts by weight, 2.67 to 4.33 parts by weight, 2.67 to 4 parts by weight, 2.67 to 3.67 parts by weight, 2.67 to 3.33 parts by weight, 2.67 to 3 parts by weight, 3 to 5 parts by weight, 3 to 4.67 parts by weight, 3 to 4.33 parts by weight, 3 to 4 parts by weight, 3 to 3.67 parts by weight, 3 to 3.33 parts by weight, 3.33 to 5 parts by weight, 3.33 to 4.67 parts by weight, 3.33 to 4.33 parts by weight, 3.33 to 4 parts by weight, 3.33 to 3.67 parts by weight, or 2.67 parts by weight,
threonine of 1 to 5 parts by weight, 1 to 4.67 parts by weight, 1 to 4.33 parts by weight, 1 to 4 parts by weight, 1 to 3.67 parts by weight, 1 to 3.33 parts by weight, 1 to 3 parts by weight, 1 to 2.67 parts by weight, 1 to 2.33 parts by weight, 1 to 2 parts by weight, 1 to 1.67 parts by weight, 1 to 1.33 parts by weight, 1.33 to 5 parts by weight, 1.33 to 4.67 parts by weight, 1.33 to 4.33 parts by weight, 1.33 to 4 parts by weight, 1.33 to 3.67 parts by weight, 1.33 to 3.33 parts by weight, 1.33 to 3 parts by weight, 1.33 to 2.67 parts by weight, 1.33 to 2.33 parts by weight, 1.33 to 2 parts by weight, 1.33 to 1.67 parts by weight, 1.67 to 5 parts by weight, 1.67 to 4.67 parts by weight, 1.67 to 4.33 parts by weight, 1.67 to 4 parts by weight, 1.67 to 3.67 parts by weight, 1.67 to 3.33 parts by weight, 1.67 to 3 parts by weight, 1.67 to 2.67 parts by weight, 1.67 to 2.33 parts by weight, 1.67 to 2 parts by weight, 2 to 5 parts by weight, 2 to 4.67 parts by weight, 2 to 4.33 parts by weight, 2 to 4 parts by weight, 2 to 3.67 parts by weight, 2 to 3.33 parts by weight, 2 to 3 parts by weight, 2 to 2.67 parts by weight, 2 to 2.33 parts by weight, 2.33 to 5 parts by weight, 2.33 to 4.67 parts by weight, 2.33 to 4.33 parts by weight, 2.33 to 4 parts by weight, 2.33 to 3.67 parts by weight, 2.33 to 3.33 parts by weight, 2.33 to 3 parts by weight, 2.33 to 2.67 parts by weight, 2.67 to 5 parts by weight, 2.67 to 4.67 parts by weight, 2.67 to 4.33 parts by weight, 2.67 to 4 parts by weight, 2.67 to 3.67 parts by weight, 2.67 to 3.33 parts by weight, 2.67 to 3 parts by weight, 3 to 5 parts by weight, 3 to 4.67 parts by weight, 3 to 4.33 parts by weight, 3 to 4 parts by weight, 3 to 3.67 parts by weight, 3 to 3.33 parts by weight, 3.33 to 5 parts by weight, 3.33 to 4.67 parts by weight, 3.33 to 4.33 parts by weight, 3.33 to 4 parts by weight, 3.33 to 3.67 parts by weight, or 1.67 parts by weight, and
lysine of 1 to 5 parts by weight, 1 to 4.67 parts by weight, 1 to 4.33 parts by weight, 1 to 4 parts by weight, 1 to 3.67 parts by weight, 1 to 3.33 parts by weight, 1 to 3 parts by weight, 1 to 2.67 parts by weight, 1 to 2.33 parts by weight, 1 to 2 parts by weight, 1 to 1.67 parts by weight, 1 to 1.33 parts by weight, 1.33 to 5 parts by weight, 1.33 to 4.67 parts by weight, 1.33 to 4.33 parts by weight, 1.33 to 4 parts by weight, 1.33 to 3.67 parts by weight, 1.33 to 3.33 parts by weight, 1.33 to 3 parts by weight, 1.33 to 2.67 parts by weight, 1.33 to 2.33 parts by weight, 1.33 to 2 parts by weight, 1.33 to 1.67 parts by weight, 1.67 to 5 parts by weight, 1.67 to 4.67 parts by weight, 1.67 to 4.33 parts by weight, 1.67 to 4 parts by weight, 1.67 to 3.67 parts by weight, 1.67 to 3.33 parts by weight, 1.67 to 3 parts by weight, 1.67 to 2.67 parts by weight, 1.67 to 2.33 parts by weight, 1.67 to 2 parts by weight, 2 to 5 parts by weight, 2 to 4.67 parts by weight, 2 to 4.33 parts by weight, 2 to 4 parts by weight, 2 to 3.67 parts by weight, 2 to 3.33 parts by weight, 2 to 3 parts by weight, 2 to 2.67 parts by weight, 2 to 2.33 parts by weight, 2.33 to 5 parts by weight, 2.33 to 4.67 parts by weight, 2.33 to 4.33 parts by weight, 2.33 to 4 parts by weight, 2.33 to 3.67 parts by weight, 2.33 to 3.33 parts by weight, 2.33 to 3 parts by weight, 2.33 to 2.67 parts by weight, 2.67 to 5 parts by weight, 2.67 to 4.67 parts by weight, 2.67 to 4.33 parts by weight, 2.67 to 4 parts by weight, 2.67 to 3.67 parts by weight, 2.67 to 3.33 parts by weight, 2.67 to 3 parts by weight, 3 to 5 parts by weight, 3 to 4.67 parts by weight, 3 to 4.33 parts by weight, 3 to 4 parts by weight, 3 to 3.67 parts by weight, 3 to 3.33 parts by weight, 3.33 to 5 parts by weight, 3.33 to 4.67 parts by weight, 3.33 to 4.33 parts by weight, 3.33 to 4 parts by weight, 3.33 to 3.67 parts by weight, or 2 parts by weight,
based on 1 part by weight of methionine, or a salt thereof.

In one embodiment, the amino acid may be,
a combination of 1) methionine, arginine of 1 to 5 parts by weight, glutamic acid of 1 to 5 parts by weight and histidine of 1 to 5 parts by weight;
2) methionine, arginine of 1 to 5 parts by weight, threonine of 1 to 5 parts by weight, histidine of 1 to 5 parts by weight and lysine of 1 to 5 parts by weight; or
3) methionine, threonine of 1 to 5 parts by weight, glutamic acid of 1 to 5 parts by weight and lysine of 1 to 5 parts by weight,
based on 1 part by weight of methionine.

When the amino acid is used in a form of a salt of an amino acid, the weight of the amino acid may be 10 to 95% (w/w), 10 to 90% (w/w), 10 to 85% (w/w), 10 to 80% (w/w), 10 to 75% (w/w), 10 to 70% (w/w), 10 to 65% (w/w), 10 to 60% (w/w), 10 to 55% (w/w), 10 to 50% (w/w), 10 to 40% (w/w), 10 to 30% (w/w), 10 to 20% (w/w), 79% (w/w), 80% (w/w), or 86% (w/w) based on the weight of the salt of the amino acid, but not limited thereto. In one specific embodiment, the weight of glutamic acid may be 86% (w/w) based on the weight of a sodium salt of glutamic acid (sodium glutamate).

In one specific embodiment, the weight of histidine may be 80% (w/w) based on the weight of hydrochloride of histidine.

In one specific embodiment, the weight of lysine may be 79% (w/w) based on the weight of hydrochloride of lysine.

### Composition and Method

One aspect provides a composition for promoting fruit ripening, comprising the amino acids or salts thereof as an active ingredient, by confirming that the amino acids or salts thereof have an efficacy to improve plant growth and/or fruit ripening

Another aspect provides a use of the amino acids for promoting fruit ripening.

Other aspect provides a use of the amino acids for preparation of a composition for promoting fruit ripening.

Other aspect provides a fertilizer composition comprising the amino acids as an active ingredient.

In the present description, the term “fertilizer” may mean a substance that causes a chemical change in soil to help plant cultivation, a substance that nourishes plants, and the like. The fertilizer may comprise at least one (for example, one or more kinds, 2 or more kinds, 3 or more kinds, or one kind, 2 kinds, 3 kinds or 4 kinds) selected from the group consisting of nitrogen, phosphorus, potassium and calcium, but not limited thereto. The fertilizer may be classified into organic fertilizers or inorganic fertilizers. The organic fertilizer may be a plant-based fertilizer or an animal-based fertilizer. The plant-based fertilizer may be compost, manure, oil cake such as sesame cake, rice bran, humus and the like, and the animal-based fertilizer may be silkworm pupa meal, bone meal, meat meal, carcass, excreta and the like. The inorganic fertilizer may be a straight fertilizer or a compound/complex fertilizer. The straight fertilizer may include nitrogenous fertilizers (including urea, ammonium sulfate, ammonium nitrate, ammonium chloride and/or lime nitrogen, etc.), phosphoric fertilizers (including superphosphate lime (single superphosphate), polysuperphosphate lime (triple superphosphate), fused phosphate, and/or fused superphosphate, etc.), potassium fertilizers (including potassium chloride and/or potassium sulfate, etc.), calcareous (calcium) fertilizers (including lime, slacked lime and/or carbonated lime, etc.), siliceous fertilizers (including calcium silicate, etc.) and the like. The compound/complex fertilizer may be a fertilizer comprising at least two or more components selected from the group consisting of nitrogen, phosphorus, potassium, silicic acid and the like.

The fertilizer may further comprise an inorganic element such as sulfur, calcium, magnesium, boron, copper, zinc, manganese, iron, molybdenum, and the like.

The fertilizer may be formulated and used in various forms such as a powder type, a granular type and the like. In the formulation, known additives, carriers and the like may be used.

Other aspect provides a method for cultivation of a plant, comprising treating the amino acid or salt thereof, or the composition (composition for promoting fruit ripening or fertilizer composition) to plants. The method may be characterized by promoting fruit ripening.

Other aspect provides a method for promoting fruit ripening, comprising treating the amino acids or salts thereof, or the composition (composition for promote fruit ripening or fertilizer composition) to a plant.

The composition may be applied directly to the surface of the soil around the plant, by mixing it with soil or drenching it over the soil. It may also be used by directly spraying or scattering on the stem, leaf, or branch of the plant, or spraying or immersing in the seed of the plant, but not limited thereto.

The amino acids and composition are as described above.

In one embodiment, the composition may comprise,
at least 2 or more amino acids selected from the group consisting of methionine, arginine, threonine, glutamic acid, histidine and lysine or a salt thereof as an active ingredient.

In one embodiment, the composition may comprise,
methionine; and,
a combination of at least one amino acid selected from the group consisting of arginine, threonine, glutamic acid, histidine and lysine.

In one embodiment, the composition may comprise
1) a combination of methionine, arginine, glutamic acid and histidine,
2) a combination of methionine, arginine, threonine, histidine and lysine, or
3) a combination of methionine, threonine, glutamic acid and lysine.

In one embodiment, the composition may comprise
1) methionine, arginine 1 to 5 parts by weight, glutamic acid 1 to 5 parts by weight and histidine 1 to 5 parts by weight;
2) methionine, arginine 1 to 5 parts by weight, threonine 1 to 5 parts by weight, histidine 1 to 5 parts by weight and lysine 1 to 5 parts by weight; or
3) methionine, threonine 1 to 5 parts by weight, glutamic acid 1 to 5 parts by weight and lysine 1 to 5 parts by weight,
based on methionine 1 part by weight.

The concentration of the amino acids in the composition (composition for promoting fruit ripening or fertilizer composition) provided in the present description may be 10 to 50% (w/w), 10 to 47.5% (w/w), 10 to 45% (w/w), 10 to 42.5% (w/w), 10 to 40% (w/w), 10 to 37.5% (w/w), 10 to 35% (w/w), 10 to 32.5% (w/w), 10 to 30% (w/w), 10 to 28% (w/w), 10 to 27.5% (w/w), 10 to 27% (w/w), 10 to 25% (w/w), 10 to 24% (w/w), 12.5 to 50% (w/w), 12.5 to 47.5% (w/w), 12.5 to 45% (w/w), 12.5 to 42.5% (w/w), 12.5 to 40% (w/w), 12.5 to 37.5% (w/w), 12.5 to 35% (w/w), 12.5 to 32.5% (w/w), 12.5 to 30% (w/w), 12.5 to 28% (w/w), 12.5 to 27.5% (w/w), 12.5 to 27% (w/w), 12.5 to 25% (w/w), 12.5 to 24% (w/w), 15 to 50% (w/w), 15 to 47.5% (w/w), 15 to 45% (w/w), 15 to 42.5% (w/w), 15 to 40% (w/w), 15 to 37.5% (w/w), 15 to 35% (w/w), 15 to 32.5% (w/w), 15 to 30% (w/w), 15 to 28% (w/w), 15 to 27.5% (w/w), 15 to 27% (w/w), 15 to 25% (w/w), 15 to 24% (w/w), 17.5 to 50% (w/w), 17.5 to 47.5% (w/w), 17.5 to 45% (w/w), 17.5 to 42.5% (w/w), 17.5 to 40% (w/w), 17.5 to 37.5% (w/w), 17.5 to 35% (w/w), 17.5 to 32.5% (w/w), 17.5 to 30% (w/w), 17.5 to 28% (w/w), 17.5 to 27.5% (w/w), 17.5 to 27% (w/w), 17.5 to 25% (w/w), 17.5 to 24% (w/w), 20 to 50% (w/w), 20 to 47.5% (w/w), 20 to 45% (w/w), 20 to 42.5% (w/w), 20 to 40% (w/w), 20 to 37.5% (w/w), 20 to 35% (w/w), 20 to 32.5% (w/w), 20 to 30% (w/w), 20 to 28% (w/w), 20 to 27.5% (w/w), 20 to 27% (w/w), 20 to 25% (w/w), 20 to 24% (w/w), 22.5 to 50% (w/w), 22.5 to 47.5% (w/w), 22.5 to 45% (w/w), 22.5 to 42.5% (w/w), 22.5 to 40% (w/w), 22.5 to 37.5% (w/w), 22.5 to 35% (w/w), 22.5 to 32.5% (w/w), 22.5 to 30% (w/w), 22.5 to 28% (w/w), 22.5 to 27.5% (w/w), 22.5 to 27% (w/w), 22.5 to 25% (w/w), 22.5 to 24% (w/w), 24 to 50% (w/w), 24 to 47.5% (w/w), 24 to 45% (w/w), 24 to 42.5% (w/w), 24 to 40% (w/w), 24 to 37.5% (w/w), 24 to 35% (w/w), 24 to 32.5% (w/w), 24 to 30% (w/w), 24 to 28% (w/w), 24 to 27.5% (w/w), or 24 to 27% (w/w), based on the weight of the amino acid compared to the weight of the composition. In one specific embodiment, the concentration of the amino acid in the composition (composition for promoting fruit ripening or fertilizer composition) may be 24% (w/v), 25% (w/v), 26% (w/v), or 27% (w/v).

In the composition (composition for promoting fruit ripening or fertilizer composition) and/or method provided in the present description, the composition to be applied to plants may be used as diluted appropriately, and for example, it may be used as diluted by 1 to 10000 times, 1 to 7500 times, 1 to 5000 times, 1 to 2500 times, 1 to 1000 times, 1 to 900 times, 1 to 800 times, 1 to 700 times, 1 to 600 times, 1 to 500 times, 1 to 400 times, 1 to 300 times, 1 to 250 times, 1 to 200 times, 1 to 100 times, 10 to 10000 times, 10 to 7500 times, 10 to 5000 times, 10 to 2500 times, 10 to 1000 times, 10 to 900 times, 10 to 800 times, 10 to 700 times, 10 to 600 times, 10 to 500 times, 10 to 400 times, 10 to 300 times, 10 to 250 times, 10 to 200 times, 10 to 100 times, 50 to 10000 times, 50 to 7500 times, 50 to 5000 times, 50 to 2500 times, 50 to 1000 times, 50 to 900 times, 50 to 800 times, 50 to 700 times, 50 to 600 times, 50 to 500 times, 50 to 400 times, 50 to 300 times, 50 to 250 times, 50 to 200 times, 50 to 100 times, 100 to 10000 times, 100 to 7500 times, 100 to 5000 times, 100 to 2500 times, 100 to 1000 times, 100 to 900 times, 100 to 800 times, 100 to 700 times, 100 to 600 times, 100 to 500 times, 100 to 400 times, 100 to 300 times, 100 to 250 times, or 100 to 200 times. In one specific embodiment, the composition may be used as diluted by 500 times. The composition may be diluted with water and the like, but not limited thereto.

In the composition (composition for promoting fruit ripening or fertilizer composition) and/or method provided in the present description, when the composition is used as diluted, it may be used as diluted so that the concentration (w/w) of the amino acids comprised in the composition is to be 0.01 to 10% (w/w), 0.01 to 5% (w/w), 0.01 to 4% (w/w), 0.01 to 3% (w/w), 0.01 to 2% (w/w), 0.01 to 1% (w/w), 0.01 to 0.9% (w/w), 0.01 to 0.8% (w/w), 0.01 to 0.7% (w/w), 0.01 to 0.6% (w/w), 0.01 to 0.5% (w/w), 0.01 to 0.4% (w/w), 0.01 to 0.3% (w/w), 0.01 to 0.2% (w/w), 0.01 to 0.1% (w/w), 0.01 to 0.05% (w/w), 0.05 to 10% (w/w), 0.05 to 5% (w/w), 0.05 to 4% (w/w), 0.05 to 3% (w/w), 0.05 to 2% (w/w), 0.05 to 1% (w/w), 0.05 to 0.9% (w/w), 0.05 to 0.8% (w/w), 0.05 to 0.7% (w/w), 0.05 to 0.6% (w/w), 0.05 to 0.5% (w/w), 0.05 to 0.4% (w/w), 0.05 to 0.3% (w/w), 0.05 to 0.2% (w/w), 0.05 to 0.1% (w/w), 0.1 to 10% (w/w), 0.1 to 5% (w/w), 0.1 to 4% (w/w), 0.1 to 3% (w/w), 0.1 to 2% (w/w), 0.1 to 1% (w/w), 0.1 to 0.9% (w/w), 0.1 to 0.8% (w/w), 0.1 to 0.7% (w/w), 0.1 to 0.6% (w/w), 0.1 to 0.5% (w/w), 0.1 to 0.4% (w/w), 0.1 to 0.3% (w/w), 0.1 to 0.2% (w/w), 0.2 to 10% (w/w), 0.2 to 5% (w/w), 0.2 to 4% (w/w), 0.2 to 3% (w/w), 0.2 to 2% (w/w), 0.2 to 1% (w/w), 0.2 to 0.9% (w/w), 0.2 to 0.8% (w/w), 0.2 to 0.7% (w/w), 0.2 to 0.6% (w/w), 0.2 to 0.5% (w/w), 0.2 to 0.4% (w/w), 0.2 to 0.3% (w/w), 0.3 to 10% (w/w), 0.3 to 5% (w/w), 0.3 to 4% (w/w), 0.3 to 3% (w/w), 0.3 to 2% (w/w), 0.3 to 1% (w/w), 0.3 to 0.9% (w/w), 0.3 to 0.8% (w/w), 0.3 to 0.7% (w/w), 0.3 to 0.6% (w/w), 0.3 to 0.5% (w/w), 0.3 to 0.4% (w/w), 0.4 to 10% (w/w), 0.4 to 5% (w/w), 0.4 to 4% (w/w), 0.4 to 3% (w/w), 0.4 to 2% (w/w), 0.4 to 1% (w/w), 0.4 to 0.9% (w/w), 0.4 to 0.8% (w/w), 0.4 to 0.7% (w/w), 0.4 to 0.6% (w/w), 0.4 to 0.5% (w/w), 0.5 to 10% (w/w), 0.5 to 5% (w/w), 0.5 to 4% (w/w), 0.5 to 3% (w/w), 0.5 to 2% (w/w), 0.5 to 1% (w/w), 0.5 to 0.9% (w/w), 0.5 to 0.8% (w/w), 0.5 to 0.7% (w/w), 0.5 to 0.6% (w/w), 0.8 to 10% (w/w), 0.8 to 5% (w/w), 0.8 to 4% (w/w), 0.8 to 3% (w/w), 0.8 to 2% (w/w), 0.8 to 1% (w/w), or 0.8 to 0.9% (w/w), but not limited thereto.
plants applicable to the composition (composition for promoting fruit ripening or fertilizer composition) and/or method provided in the present description are not particularly limited, and for example, it may be applicable to a plant of genus Coffea (for example, Arabica coffee tree (Coffea arabica L.), liberica coffee (Coffea liberica), Robusta coffee (Coffea canephora)), a plant of the genus Solanum (for example, tomato (Solanum lycopersicum), cherry tomato (Solanum lycopersicum var. cerasiforme), potato (Solanum tuberosum), naranjilla (Solanum quitoense), tamarillo (Solanum betaceum), pepino melon (Solanum muricatum)), a plant of genus Capsicum (for example, chili (C. annuum), Capsicum frutescens (C. frutescens), Capsicum baccatum (C. baccatum), Capsicum chinese (C. chinense), Capsicum pubescens (C. pubescens)), or a plant of genus Malus (for example, Malus pumila), or the like, but not limited thereto. In the present description, the fruit means one which an ovary and the like develops into after fertilization.

The parts of plants applicable to the composition (composition for promoting fruit ripening or fertilizer composition) and/or method provided in the present description are not particularly limited, and for example, it may be at least one selected from the group consisting of a whole plant, seed, root, leaf (for example, upper surface of leaves and/or lower surface of leaves, foliar fertilization or foliar spray), stem, flower, and the like.

In one embodiment, the amount of the composition to be applied to a plant may be treated in a capacity of about 1 to 1000 ml, 1 to 900 ml, 1 to 800 ml, 1 to 700 ml, 1 to 600 ml, 1 to 500 ml, 1 to 400 ml, 1 to 300 ml, 1 to 200 ml, 1 to 100 ml, 1 to 90 ml, 1 to 80 ml, 1 to 70 ml, 1 to 60 ml, 1 to 50 ml, 1 to 40 ml, 1 to 35 ml, 1 to 30 ml, 1 to 20 ml, 1 to 10 ml, 5 to 1000 ml, 5 to 900 ml, 5 to 800 ml, 5 to 700 ml, 5 to 600 ml, 5 to 500 ml, 5 to 400 ml, 5 to 300 ml, 5 to 200 ml, 5 to 100 ml, 5 to 90 ml, 5 to 80 ml, 5 to 70 ml, 5 to 60 ml, 5 to 50 ml, 5 to 40 ml, 5 to 35 ml, 5 to 30 ml, 5 to 20 ml, 5 to 10 ml, 10 to 1000 ml, 10 to 900 ml, 10 to 800 ml, 10 to 700 ml, 10 to 600 ml, 10 to 500 ml, 10 to 400 ml, 10 to 300 ml, 10 to 200 ml, 10 to 100 ml, 10 to 90 ml, 10 to 80 ml, 10 to 70 ml, 10 to 60 ml, 10 to 50 ml, 10 to 40 ml, 10 to 35 ml, 10 to 30 ml, 10 to 20 ml, 50 to 1000 ml, 50 to 900 ml, 50 to 800 ml, 50 to 700 ml, 50 to 600 ml, 50 to 500 ml, 50 to 400 ml, 50 to 300 ml, 50 to 200 ml, 50 to 100 ml, 50 to 90 ml, 50 to 80 ml, 50 to 70 ml, 50 to 60 ml, 50 to 1000 ml, 50 to 900 ml, 50 to 800 ml, 50 to 700 ml, 50 to 600 ml, 50 to 500 ml, 50 to 400 ml, 50 to 300 ml, 50 to 200 ml, 50 to 100 ml, 50 to 90 ml, 50 to 80 ml, 50 to 70 ml, 50 to 60 ml, 100 to 1000 ml, 100 to 900 ml, 100 to 800 ml, 100 to 700 ml, 100 to 600 ml, 100 to 500 ml, 100 to 400 ml, 100 to 300 ml, 100 to 200 ml, 200 to 1000 ml, 200 to 900 ml, 200 to 800 ml, 200 to 700 ml, 200 to 600 ml, 200 to 500 ml, 200 to 400 ml, or 200 to 300 ml, once, but not limited thereto.

The composition may be treated to plants once to 20 times, once to 15 times, once to 10 times, once to 9 times, once to 8 times, once to 7 times, once to 6 times, once to 5 times, once to 4 times, or once to 3 times, in total, and may be treated at an interval of one day, at an interval of 2 days, at an interval of 3 days, at an interval of 5 days, at an interval of 7 days (or 1 week), at an interval of 10 days, at an interval of 14 days (or 2 weeks), at an interval of 15 days, at an interval of 20 days, at an interval of 21 days (or 3 weeks), at an interval of 25 days, at an interval of 28 days (or 4 weeks), at an interval of 30 days (or 1 month), at an interval of 45 days, or at an interval of 60 days (or 2 months), but not limited thereto.

### Advantageous Effects

By treating the composition comprising the amino acids of the present application to plants, it is confirmed that it prominently promotes the plant growth and/or fruit ripening.

### BRIEF DESCRIPTION OF THE DRAWINGS

FIG. 1 is photographs of harvested cherry tomato fruits after applying the C1, C2 treatment and the composition of CJ1 to CJ4, taken with a general camera and a hyperspectral imaging equipment.

FIG. 2 shows the ratio of the ripened fruits (upper graph) and yield of the fruits (g, lower graph), by applying the C1, C2 treatment and the composition of CJ1 to CJ4 to cherry tomato trees.

FIG. 3 is photographs of harvested coffee cherries after applying the C1, C2 treatment and the composition of CJ2, CJ3, taken with a general camera and a hyperspectral imaging equipment.

FIG. 4 shows the ratio of the ripened fruits (upper graph) and ripening rate of fruits (lower graph), by applying the C1, C2 treatment and the composition of CJ2, CJ3 to coffee trees.

### MODE FOR INVENTION

Hereinafter, the present invention will be more specifically described by the following examples. However, they are intended to illustrate the present invention only, but the scope of the present invention is not limited by these examples.

### Example 1. Preparation of Amino Acid Combination With Ripening Efficacy for Cherry Tomatoes

After fruit set had occurred on cherry tomato trees (Solanum lycopersicum var. cerasiforme), the composition according to Table 1 below was diluted in water by 500 times, and about 35ml (based on 25,000 trees/ha, 975 L/ha fertilization) of solutions was applied as foliar spray, 3 times at 7-day intervals. ha means 10,000 m² area.

TABLE 1

| Treatment | |
|---|---|
| group | Component |
| C1 | Water 100%(w/w) |
| C2 | Company S product |
| CJ1 | Water 61%(w/w), ammonium phosphate 2%(w/w), potassium chloride |
| | 10%(w/w), Met 3%(w/w), Arg 8%(w/w), MSG 8%(w/w), His-HCl 8%(w/w) |
| CJ2 | Water 62%(w/w), urea 1%(w/w), ammonium phosphate 2%(w/w), potassium |
| | chloride 10%(w/w), Met 3%(w/w), Arg 3%(w/w), Thr 5%(w/w), His-HCl |
| | 8%(w/w), Lys-HCl 6%(w/w) |
| CJ3 | Water 59%(w/w), urea 5%(w/w), ammonium phosphate 2%(w/w), potassium |
| | chloride 10%(w/w), Met 3%(w/w), Thr 5%(w/w), MSG 10%(w/w), Lys-HCl |
| | 6%(w/w) |
| CJ4 | Water 59.5%(w/w), urea 5.5%(w/w), ammonium phosphate 2%(w/w), |
| | potassium chloride 10%(w/w), Met 2%(w/w), Ile 0.5%(w/w), Thr 5%(w/w), |
| | MSG 9%(w/w), Lys-HCl 6.5%(w/w) |

In Table 1 above, the Company S product of C2 (Isabion of Sygenta [symbol] , hydrolyzed amino acid product, comprising about 60% (w/w) of amino acids) was obtained from Plant Protection.com. The composition of CJ1 to CJ4 was prepared by mixing the components described in Table 1 according to the ratio.

### Example 2. Verification of Efficacy of Amino Acid Combination With Ripening Efficacy for Cherry Tomatoes

After harvesting the fruits from a cherry tomato tree, the ripeness of the fruits was measured by visual evaluation (general camera photographing) and utilizing a hyperspectral imaging equipment by utilizing the hyperspectral imaging equipment, spectrums of the fruit surface were analyzed and compared to that of the control group. The ratio of the spectrum of the ripened fruits' surfaces above a certain level to the entire spectrums was calculated to evaluate the ratio value of the ripened fruits.

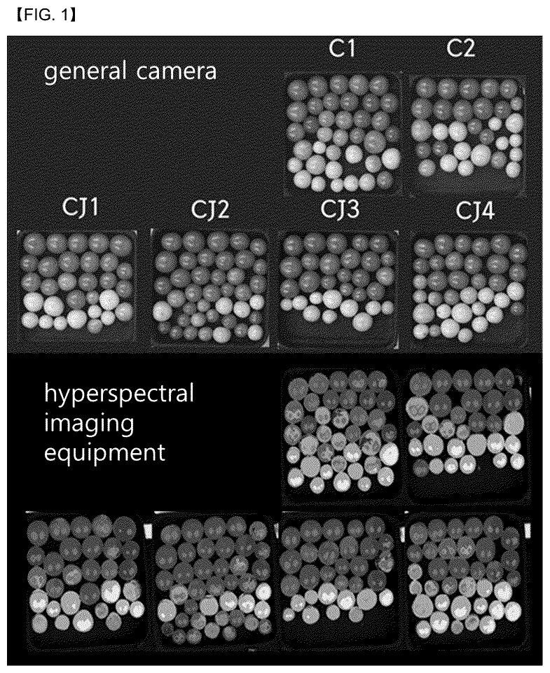

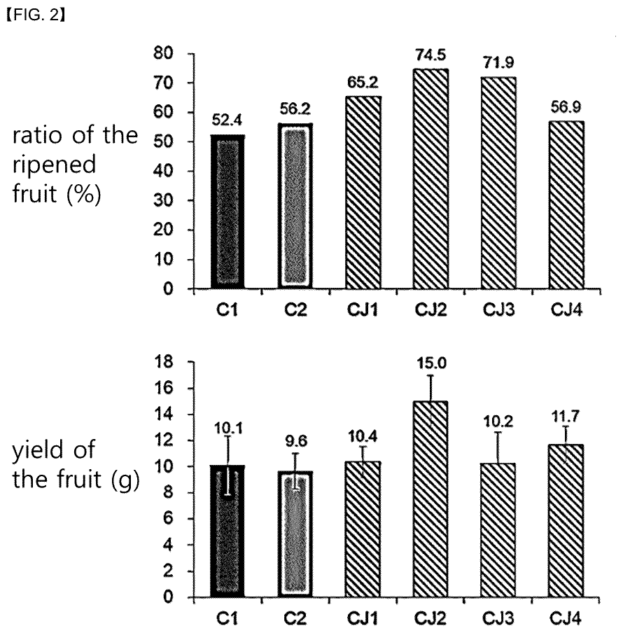

The photographs taken by general camera and the hyperspectral imaging equipment were shown in FIG. 1, and the graphs showing the ripened fruit ratio (%) and yield (g) were shown in FIG. 2.

As the results of visual evaluation and hyperspectral imaging analysis are shown in the photographs of FIG. 1 and the upper graph of FIG. 2, it was confirmed that the ripening efficacy of CJ1 to CJ3 treatment groups was excellent, compared to the that of C1 treatment group (water), and C2 treatment group.

In particular, In the lower graph of FIG. 2, it was confirmed that the CJ1 to CJ3 treatment groups did not reduce the yield but had an excellent fruit ripening efficacy, compared to the control group (C1, C2 treatment groups). Also among the treatments, CJ2 treatment group particularly had an outstanding fruit ripening efficacy and simultaneously, increased the yield significantly.

### Example 3. Preparation of Amino Acid Combination With Ripening Efficacy for Coffee

After coffee cherries (Coffea arabica L.) had enlarged, the composition according to Table 2 below was diluted in water by 500 times, and about 500 ml (based on 1,700 trees/ha, 850 L/ha fertilization) of solutions was treated as foliar application, 3 times at one-month intervals

TABLE 2

| Treatment | |
|---|---|
| group | Component |
| C1 | Water 100%(w/w) |
| C2 | Company S product |
| CJ2 | Water 62%(w/w), urea 1%(w/w), ammonium phosphate 2%(w/w), potassium |
| | chloride 10%(w/w), Met 3%(w/w), Arg 3%(w/w), Thr 5%(w/w), His-HCl |
| | 8%(w/w), Lys-HCl 6%(w/w) |
| CJ3 | Water 59%(w/w), urea 5%(w/w), ammonium phosphate 2%(w/w), potassium |
| | chloride 10%(w/w), Met 3%(w/w), Thr 5%(w/w), MSG 10%(w/w), Lys-HCl |
| | 6%(w/w) |

In Table 2 above, the C2 is the Company S product (including similar ingredients to Mathury, a product for coffee of Satis company, 35% (w/w) potassium acetate), and C1, CJ2 and CJ3 treatment groups are as Table 1.

### Example 4. Verification of Efficacy of Amino Acid Combination With Ripening Efficacy for Coffee

After harvesting the fruits from coffee trees, the ripeness of the fruit was measured by visual evaluation (general camera photographing) and utilizing a hyperspectral imaging equipment by utilizing the hyperspectral imaging equipment, spectrums of the fruit surface were analyzed and compared to that of the control group. The ratio of the spectrum of the ripened fruits' surface above a certain level to the entire spectrums was calculated to evaluate the ratio value of the ripened fruits.

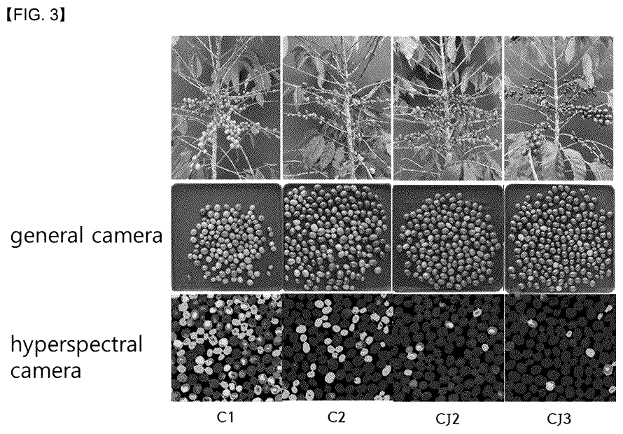

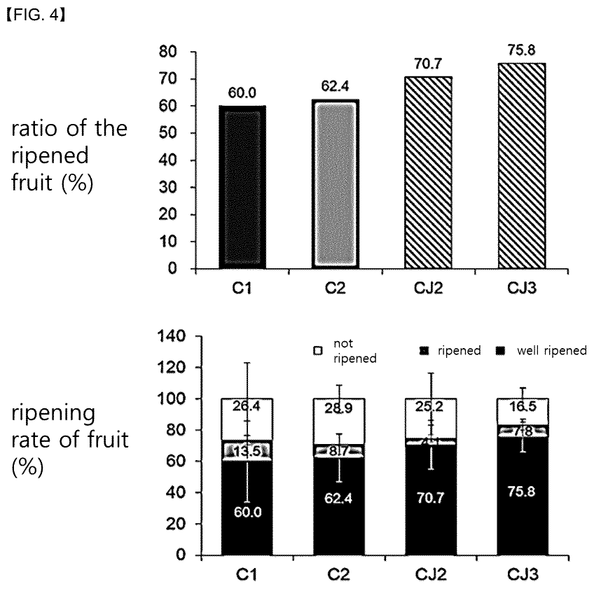

The photographs taken by general camera and the hyperspectral imaging equipment were shown in FIG. 3, and a graph showing the ripened fruit ratio was shown in FIG. 4.

As shown in the results of visual evaluation and hyperspectral imaging analysis in the photograph of FIG. 3 and the upper graph of FIG. 4, it was confirmed that the ripening efficacy of the CJ2 and CJ3 treatment groups was excellent, compared to the C1 treatment group (water) or C2 treatment group.

Coffee fruits are considered to have better quality when the ratio of well-ripened fruits to the harvested ones is higher. Therefore, as shown in Table 3 below and the lower graph of FIG. 4, it was confirmed that the CJ2 and CJ3 treatment groups had high-quality fruits compared to the control group (C1 and C2 treatment groups), since they had a higher ratio of the well-ripened fruit to the ripened fruit.

TABLE 3

| | | Well ripened | Well ripened |
|---|---|---|---|
| Treatment | Ripened fruit ratio (%) | fruit ratio (%) | fruit ratio in |
| group | (ripened + well ripened) | (well ripened) | ripened fruit (%) |
| C1 | 73.5 | 60 | 81.63 |
| C2 | 71.1 | 62.4 | 87.76 |
| CJ2 | 74.8 | 70.7 | 94.52 |
| CJ3 | 83.6 | 75.8 | 90.67 |

From the above description, those skilled in the art to which the present application pertains will be able to understand that the present application may be embodied in other specific forms without changing the technical spirit or essential characteristics. In this regard, it should be understood that the examples described above are illustrative and not restrictive in all respects. The scope of the present application should be construed as including all changes or modifications derived from the meaning and scope of the claims to be described below and equivalent concepts rather than the detailed description above, in the scope of the present application.

1-15. (canceled)

16. A method for promoting fruit ripening in a subject in need thereof, comprising administering a composition comprising at least two amino acids selected from the group consisting of methionine, arginine, threonine, glutamic acid, histidine and lysine or a salt thereof to the subject.

17. The method according to claim 16, wherein the amino acid is a combination of
(1) methionine; and,
(2) at least one amino acid selected from the group consisting of arginine, threonine, glutamic acid, histidine and lysine.

18. The method according to claim 16, wherein the amino acid is:
(1) a combination of methionine, arginine, glutamic acid and histidine;
(2) a combination of methionine, arginine, threonine, histidine and lysine; or
(3) a combination of methionine, threonine, glutamic acid and lysine.

19. The method according to claim 18, wherein the composition comprises:
(1) arginine of 1 to 5 parts by weight, glutamic acid of 1 to 5 parts by weight and histidine of 1 to 5 parts by weight;
(2) arginine of 1 to 5 parts by weight, threonine of 1 to 5 parts by weight, histidine of 1 to 5 parts by weight and lysine of 1 to 5 parts by weight; or
(3) threonine of 1 to 5 parts by weight, glutamic acid of 1 to 5 parts by weight and lysine of 1 to 5 parts by weight,
based on methionine of 1 part by weight.

20. The method according to claim 16, wherein a concentration of the amino acid in the composition is 10 to 50% (w/w).

21. The method according to claim 16, wherein to the subject is any one plant selected from the group consisting of plant of genus Coffea, plant of genus Solanum, plant of genus Capsicum and plant of genus Malus.

22. A method for cultivating a plant, comprising administering a composition comprising at least two amino acids selected from the group consisting of methionine, arginine, threonine, glutamic acid, histidine and lysine or a salt thereof to the plant.

23. The method according to claim 22, wherein the amino acid is a combination of
(1) methionine; and,
(2) at least one amino acid selected from the group consisting of arginine, threonine, glutamic acid, histidine and lysine.

24. The method according to claim 22, wherein the amino acid is:
(1) a combination of methionine, arginine, glutamic acid and histidine;
(2) a combination of methionine, arginine, threonine, histidine and lysine; or
(3) a combination of methionine, threonine, glutamic acid and lysine.

25. The method according to claim 22, wherein the composition comprises:
(1) arginine of 1 to 5 parts by weight, glutamic acid of 1 to 5 parts by weight and histidine of 1 to 5 parts by weight;
(2) arginine of 1 to 5 parts by weight, threonine of 1 to 5 parts by weight, histidine of 1 to 5 parts by weight and lysine of 1 to 5 parts by weight; or
(3) threonine of 1 to 5 parts by weight, glutamic acid of 1 to 5 parts by weight and lysine of 1 to 5 parts by weight,
based on methionine of 1 part by weight.

26. The method according to claim 22, wherein a concentration of the amino acid in the composition is 10 to 50% (w/w).

27. The method according to claim 22, wherein the subject is any one plant selected from the group consisting of plant of genus Coffea, plant of genus Solanum, plant of genus Capsicum and plant of genus Malus.

28. The method according to claim 22, wherein the method promotes fruit ripening.
